(19) United States
(12) Patent Application Publication
(10) Pub. No.: US 2026/0326232 A1
(43) Pub. Date: Oct. 22, 2026

(54) METAL FOIL CUTTING WITH PULSED FIBER LASER BEAM

(71) Applicant: Corelase Oy, Tampere (FI)

(72) Inventor: Jarno KANGASTUPA, Tampere (FI)

(73) Assignee: Corelase Oy, Tampere (FI)

(21) Appl. No.: 19/484,617

(22) PCT Filed: May 18, 2023
(86) PCT No.: PCT/EP2023/063434

§ 371 Date: Nov. 14, 2025

(51) Int. Cl. B23K 26/0622; B23K 26/38

(52) U.S. Cl. CPC B23K 26/0622; B23K 26/38

(57) ABSTRACT

A method for laser cutting metal foils includes generating a linearly polarized CW laser beam with a fiber laser system, modulating diffraction of the continuous-wave laser beam by an acousto-optic modulator to produce a pulsed laser beam, and cutting a metal foil with the pulsed laser beam. The present method can modulate a high-power CW laser beam on and off at a high modulation rate, e.g., 100 kilohertz or more, to generate a pulsed laser beam. The power of the CW laser beam may be between 0.5 and several kilowatts. Modulation may be done with a duty cycle of approximately 50%. This method is thus capable of providing high average-power while operating with sufficiently short pulses and sufficiently long time between pulses to keep the heat-affected zone small.

### CROSS-REFERENCE TO RELATED APPLICATIONS

This application is a U.S. national stage application under 35 U.S.C. § 371 of International Application No. PCT/EP2023/063434, filed May 18, 2023.

### FIELD OF THE DISCLOSURE

The present invention relates in general to laser cutting of metal foils, in particular as applied to the production of lithium-ion batteries.

### BACKGROUND OF THE DISCLOSURE

There is a strong push towards emission-free transportation. This effort involves phasing out the large existing fleet of diesel-and gasoline-powered vehicles and replacing these vehicles with electric vehicles, with minimal additional financial burden, if any, placed on the consumer. Efficient lithium-ion battery technology and cost-effective manufacture are paramount to the success of this effort.

The smallest unit of a lithium-ion battery cell consists of an anode, a cathode, a separator, and an electrolyte liquid. The electrolyte liquid and the separator are disposed between the anode and cathode. Both the anode and cathode are coated metal foils cut in particular shapes and sizes. The metal foils usually have a thickness of about 10 micrometers (μm). Most often, the anode is a copper foil coated with lithium graphite, and the cathode is an aluminum foil coated with a lithium metal oxide. A typical cutting process for either one of the anode and cathode starts with a “mother” coil of a relatively wide, coated metal foil. The mother coil is unrolled and cut lengthwise into several narrower foils. The narrower foils are rolled up into “daughter” coils. The lengthwise cutting is performed on the fly as the metal foil transfers from the mother coil to the daughter coils. Next, each daughter coil is unrolled and cut into a large number of smaller pieces of the desired geometry. This geometry is, for example, a rectangle with a small tab extending away from one of the sides of the rectangle. Mechanical cutting of metal foils is relatively slow and forms a bottleneck in the manufacture of lithium-ion batteries. Laser cutting has the potential to significantly reduce the cutting time and improve precision.

Nanosecond and picosecond laser beams are used to cut metal foils. The laser beam is focused on the metal foil, and the focus location is scanned relative to the metal foil to generate the required cut. At least part of the scanning may be achieved by translating the metal foil. In addition, laser processing heads are commonly equipped with a beam scanner that can steer the laser beam. Nano-and picosecond lasers can produce relatively high peak-powers, sufficient for the cutting process, while the short pulse durations limit the size of the heat-affected zone. A small heat-affected zone is critical to achieve cuts of high precision and quality.

### SUMMARY OF THE DISCLOSURE

Although nano-and picosecond lasers produce high peak-powers, their average power is relatively low, usually no more than about 100 watts. For comparison, continuous-wave (CW) fiber lasers can produce diffraction-limited beams with multi-kilowatt average powers. The low average-power of nano-and picosecond lasers limits the speed with which such lasers can cut a metal foil. Essentially, the ratio of pulse duration to time between pulses is unfavorable for high-speed cutting. That is, the duty cycle is rather low.

Disclosed herein is a method for laser cutting of metal foils that provides high average-power while operating with sufficiently short pulses and sufficiently long time between pulses to keep the heat-affected zone small. The present method modulates a high-power CW laser beam on and off at a high modulation rate, e.g., 100 kilohertz (kHz) or more, to generate a pulsed laser beam. The CW laser beam is generated by a fiber laser system, and the power of the CW laser beam may be between 0.5 and several kilowatts (kW). Modulation is performed by an acousto-optic modulator (AOM) and may be done with a duty cycle of approximately 50%. The power within each pulse is sufficient to cut the metal foil, and the modulation rate is high enough to keep the heat-affected zone small.

The present method utilizes a high-power CW fiber laser that produces a linearly polarized laser beam. More commonly, high-power fiber laser systems produce laser beams with random polarization. The polarization of these beams changes randomly and frequently. AOMs operating with acoustic shear waves can be polarization insensitive and can therefore modulate a randomly polarized input beam. However, shear-wave AOMs are limited to low modulation rates. High modulation rates require an AOM operating with acoustic compression waves. Compression-wave AOMs are strongly polarization-dependent. The present use of a linearly polarized CW fiber laser allows for using a compression-wave AOM and thereby allows for acousto-optic modulation at a high modulation rate.

In one aspect of the invention, a method for laser cutting metal foils includes generating a linearly polarized CW laser beam with a fiber laser system, modulating diffraction of the linearly polarized CW laser beam by an acousto-optic modulator to produce a pulsed laser beam, and cutting a metal foil with the pulsed laser beam.

In another aspect of the invention, an apparatus for laser cutting metal foils includes a fiber laser system configured to generate a linearly polarized CW laser beam, an acousto-optic modulator arranged to receive the linearly polarized CW laser beam, a radio-frequency generator configured to modulate diffraction of the linearly polarized CW laser beam by the acousto-optic modulator to produce a pulsed laser beam, and a processing head configured to direct the pulsed laser beam to a metal foil and focus the pulsed laser beam on the metal foil.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIG. 1 illustrates an apparatus for laser cutting a metal foil with a pulsed laser beam generated from a CW laser beam, according to an embodiment.

FIG. 2 depicts exemplary power as a function of time for the pulsed laser beam generated by the FIG. 1 apparatus.

FIG. 3 illustrates a technique for scanning of the pulsed laser beam, generated by the FIG. 1 apparatus, to cut a metal foil, according to an embodiment.

FIG. 4 illustrates another technique for scanning of the pulsed laser beam, generated by the FIG. 1 apparatus, to cut a metal foil, wherein the pulsed laser beam has a rectangular beam shape, according to an embodiment.

FIG. 5 is a plot of an exemplary measured temporal power profile of a CW laser beam generated by a fiber laser system in the FIG. 1 apparatus.

### DETAILED DESCRIPTION OF THE DISCLOSURE

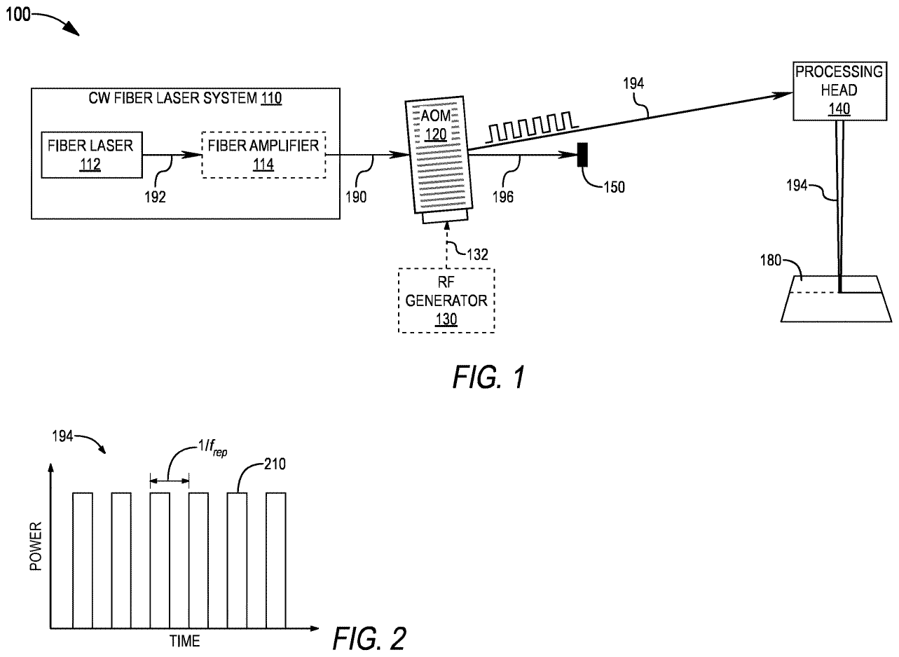

Referring now to the drawings, wherein like components are designated by like numerals, FIG. 1 illustrates one apparatus 100 for laser cutting a metal foil 180. Apparatus 100 includes a CW fiber laser system 110, an AOM 120, and a processing head 140. Herein, a fiber laser system is a laser system that implements one or more optical fibers as gain media. In operation, CW fiber laser system 110 generates a linearly polarized CW laser beam 190, AOM 120 modulates CW laser beam 190 to generate a pulsed laser beam 194, and processing head 140 directs pulsed laser beam 194 to metal foil 180 to cut metal foil 180.

The thickness of metal foil 180 may be in the range between 1 and 100 um. Metal foil 180 may be coated. In one scenario, metal foil 180 is an aluminum foil or a copper foil. The aluminum foil may be coated with lithium metal oxide, and the copper foil may be coated with lithium graphite. After cutting by apparatus 100, metal foil 180 may be incorporated into an electric battery. In scenarios where metal foil 180 is coated, laser cutting of metal foil 180 by apparatus 100 entails cutting through both the metal material and the coating.

CW fiber laser system 110 generates CW laser beam 190 with a high average-power. In one implementation, the power of CW laser beam 190 is at least 0.5 kW, for example in the range between 0.5 and 2.0 kW. AOM 120 modulates CW laser beam 190 at a high modulation rate, for example a modulation rate of at least 100 kHz. The linear polarization of CW laser beam 190 ensures compatibility with AOM 120 being of the compression-wave type.

Although a linearly polarized laser beam may be obtained by passing an unpolarized or randomly polarized laser beam through a polarization filter, such filtering imposes a loss. Additionally, any temporal variation in the polarization of the unpolarized or randomly polarized laser beam translates to temporal power variation in the polarization-filtered output beam. To avoid such loss and temporal power variation, CW fiber laser system 110 generates CW laser beam 190 with linear polarization. In order to achieve this linear polarization, the gain fiber(s) of CW fiber laser system 110 and any transport fibers following the gain fiber(s) may be polarization-maintaining optical fiber(s). CW laser beam 190 may be characterized by a polarization extinction ratio of 15 decibels or more.

CW fiber laser system 110 includes a CW fiber laser 112. In one embodiment, CW fiber laser 112 generates CW laser beam 190 directly. In another embodiment, CW fiber laser 112 generates a CW seed laser beam 192, and CW fiber laser system 110 further includes one or more fiber amplifiers 114 that amplify CW seed laser beam 192 to generate CW laser beam 190. Preferably, for the reasons discussed above, the gain fiber(s) of CW fiber laser 112, the gain fiber(s) of fiber amplifier 114 (if included), as well as any transport fibers (at least after the gain fiber(s) of CW fiber laser 112) are polarization-maintaining optical fibers. Thus, in embodiments of CW fiber laser system 110 including both CW fiber laser 112 and one or more fiber amplifiers 114, CW seed laser beam 192 is preferably linearly polarized.

Optionally, apparatus 100 further includes an RF generator 130. Embodiments of apparatus 100 that do not include RF generator are configured to receive RF signal 132 from a separately obtained RF generator 130. RF generator 130 is configured to generate an RF signal 132 that produces an acoustic wave in AOM 120. RF generator 130 modulates the acoustic wave in AOM 120 on and off, thereby modulating on and off the diffraction of CW laser beam 190 by AOM 120. In the depicted embodiment, a diffraction order of AOM 120 is selected as the output forming pulsed laser beam 194. The diffraction efficiency of AOM 120 depends on a variety of factors but the highest possible efficiency for diffraction into a single diffraction order is usually achieved for the first diffraction order. This diffraction efficiency may exceed 80%. In the interest of maximizing power in pulsed laser beam 194, the first diffraction order of AOM 120 may therefore be selected as pulsed laser beam 194.

Processing head 140 focuses pulsed laser beam 194 on metal foil 180, so as to achieve high intensity and a small heat-affected zone. The smallest achievable spot size of pulsed laser beam 194 at its focus depends on the transverse-mode properties of pulsed laser beam 194. In certain embodiments, CW laser beam 190 and pulsed laser beam 194 are single-transverse-mode beams, which is optimal for achieving a small spot size at the focus. CW fiber laser system 110 may implement its gain fiber(s) as single-mode optical fiber(s) or large-mode-area optical fiber(s) in order to generate CW laser beam 190 as a single-transverse-mode beams. Without departing from the scope hereof, a small level of mode contamination may be present in single-transverse-mode embodiments of CW laser beam 190 and pulsed laser beam 194. In one example, at least 90% of the power of each of these single-transverse-mode laser beams resides in a single transverse mode, while the remaining power is in one or more other transverse modes.

In one embodiment, processing head 140 includes a beam scanner. In this embodiment, processing head 140 may scan the location of pulsed laser beam 194 along metal foil 180 as needed to make a desired cut. In another embodiment, processing head 140 is configured to emit pulsed laser beam 194 along a fixed direction. Whether or not processing head 140 is capable of scanning pulsed laser beam 194, metal foil 180 may be mounted in a workstation that moves metal foil 180 through pulsed laser beam 194 as needed to make a cut, with or without simultaneous scanning of pulsed laser beam 194.

FIG. 2 depicts exemplary power of pulsed laser beam 194 as a function of time. The power of pulsed laser beam 194 alternates regularly between an on-level and an off-level. Pulsed laser beam 194 thereby forms a train of laser pulses 210 characterized by a pulse repetition rate frep. Repetition rate frep equals the modulation rate at which RF generator 130 modulates on and off diffraction by AOM 120. Repetition rate frep may be 100 kHz. In one example, repetition rate frep is in the range between 100 and 500 kHz. Because pulsed laser beam 194 is a diffraction order of AOM 120, the off-level is very close to true zero, for example resulting in an on-off contrast ratio of at least 100. In the depicted scenario, RF generator 130 modulates the diffraction at a duty cycle that is approximately 50%, e.g., between 40% and 60%. Such an approximately 50% duty cycle may provide an optimal balance between cutting speed and size of the heat-affected zone. The duty cycle may be adjusted when approaching corners of the cut line where the speed is typically lower than in straight sections of the cut line.

Referring again to FIG. 1, diffraction by AOM 120 is usually never complete. That is, even when the acoustic wave is present in AOM 120, at least a portion of CW laser beam 190 passes through AOM 120 undiffracted. Apparatus 100 may include a beam dump 150 positioned to block this undiffracted laser beam 196.

Undiffracted laser beam 196 is pulsed as well, although with a much lower on-off contrast ratio than the diffraction orders of AOM 120. In an alternative embodiment, not depicted in FIG. 1, undiffracted laser beam 196 is selected as pulsed laser beam 194. This alternative embodiment has the advantage of each laser pulse having nearly the same power as CW laser beam 190. However, the power level between laser pulses is significantly above zero, typically equaling about 10% or more of the power of CW laser beam 190. This substantial between-pulses power leakage may result in a larger heat-affected zone when cutting metal foil 180. Similar between-pulses power leakage may occur in embodiments where RF generator 130 does not modulate the diffraction by AOM 120 completely off. A certain amount of between-pulses power leakage may be acceptable in some scenarios.

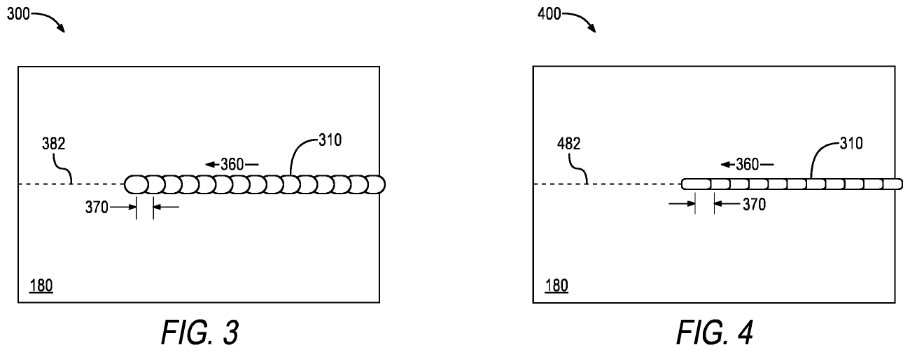

FIG. 3 illustrates one technique 300 for scanning of pulsed laser beam 194 to cut metal foil 180. In this technique, processing head 140 focuses pulsed laser beam 194 on metal foil 180. The focus location of pulsed laser beam 194 is scanned along a line 382 on metal foil 180 in the direction indicated by arrow 360. This scanning may be performed by steering pulsed laser beam 194 with processing head 140 and/or by translating metal foil 180. The focus location of pulsed laser beam 194 is scanned, relative to metal foil 180, such that the centers of adjacent individual laser pulses 310 are offset from each other by a distance 370. For a given pulse repetition rate frep and duty cycle of pulsed laser beam 194, the spatial overlap between individual laser pulses 310 can be adjusted by changing the rate of scanning along line 382. Such adjustment of the spatial overlap between adjacent pulses can be used to minimize the heat-affected zone and to achieve sufficient edge straightness.

In the example depicted in FIG. 3, pulsed laser beam 194 has a circular transverse profile when incident on metal foil 180, the duty cycle of pulsed laser beam 194 is 50%, and pulsed laser beam 194 is scanned continuously along line 382. The 50% duty cycle results in each laser pulse 310 irradiating an elongated region along line 382. With the circular beam shape, technique 300 is equally applicable to scanning of curved and straight lines 382.

FIG. 4 illustrates another technique 400 for scanning of pulsed laser beam 194 to cut metal foil 180, with pulsed laser beam 194 shaped to be more rectangular. The rectangular beam shape is particularly well-suited for scanning a straight line 482. Apart from this particular choice of beam shape, technique 400 is similar to technique 300. Apparatus 100 may implement an optical fiber with a rectangular core to give pulsed laser beam 194 a rectangular transverse profile at metal foil 180. The rectangular fiber core may be square or oblong. In one implementation, the rectangular fiber is implemented between AOM 120 and processing head 140. Pulsed laser beam 194 is directed onto metal foil 180 such that a side of the rectangular beam shape is parallel to straight line 482. As compared to the circularly-shaped pulsed laser beam in the embodiment of technique 300 depicted in FIG. 3, the rectangularly-shaped version of pulsed laser beam 194 may provide a straighter cutting-edge along line 482.

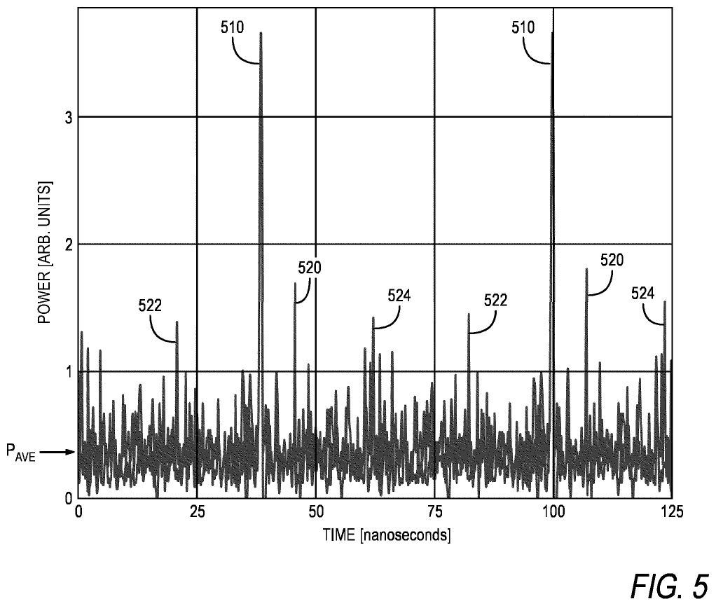

FIG. 5 is a plot of an exemplary measured temporal power profile of CW laser beam 190 generated by CW fiber laser system 110. In this example, CW laser beam 190 is noisy and contains substantial power spikes. The duration of the power spikes is measured to be less than 400 picoseconds (ps). However, this measurement was limited by the bandwidth of the detector, and the actual duration of the power spikes is estimated to be on the order of 100 ps or less. The peak power of power spikes 510 is almost ten times the average power P_{AVE} of CW laser beam 190. In a more general example, the peak power of power spikes 510 may be at least five times average power P_{AVE}. The average power P_{AVE} of CW laser beam 190 is approximately 1 kW in the depicted example. The time between consecutive power spikes 510 coincides with the round-trip time in the laser resonator of CW fiber laser 112. CW laser beam 190 contains many other smaller but yet significant power spikes that also repeat for each resonator round-trip. Some of these smaller power spikes are labeled in FIG. 5 as power spikes 520, 522, and 524. Each of power spikes 520, 522, and 524 has a peak power that is more than three times average power P_{AVE}. Pulsed laser beam 194 retains the power spikes that are within the temporal envelopes of the individual laser pulses of pulsed laser beam 194.

The fact that the most significant power spikes (e.g., power spikes 510, 520, 522, and 524) repeat for every round-trip in CW fiber laser 112 indicates that these power spikes may be caused by beating of longitudinal modes of CW fiber laser 112. Photon shot noise contained in amplified spontaneous emission in fiber laser 112 and/or fiber amplifier 114 may contribute to power spikes as well.

Particularly for metal foils of highly reflective materials, such as aluminum and copper, the power spikes may help initiate the cutting process. For such materials, the high peak power of the power spikes may promote energy in-coupling into the material through nonlinear absorption mechanisms. The general power level of pulsed laser beam 194 may be too low for these nonlinear absorption mechanisms to be of significance in the absence of the power spikes.

The present invention is described above in terms of a preferred embodiment and other embodiments. The invention is not limited, however, to the embodiments described and depicted herein. Rather, the invention is limited only by the claims appended hereto.

What is claimed is:

1. A method for laser cutting metal foils, comprising steps of:
generating a continuous-wave laser beam with a fiber laser system, the continuous-wave laser beam being linearly polarized;
modulating diffraction of the continuous-wave laser beam by an acousto-optic modulator to produce a pulsed laser beam; and
cutting a metal foil with the pulsed laser beam.

2. The method of claim 1, wherein the generating step generates the continuous-wave laser beam with an average power of at least 0.5 kilowatts, and the modulating step modulates the diffraction of the continuous-wave laser beam at a frequency of at least 100 kilohertz, such that the pulsed laser beam has a pulse repetition rate of at least 100 kilohertz.

3. The method of claim 1, wherein the generating step includes:
producing a seed laser beam in a fiber laser, the seed laser beam being linearly polarized and continuous-wave, and
amplifying the seed laser beam in a fiber amplifier to generate the continuous-wave laser beam.

4. The method of claim 1, wherein the modulating step modulates the diffraction of the continuous-wave laser beam on and off at a duty cycle of between 40% and 60%.

5. The method of claim 1, wherein the modulating step generates the pulsed laser beam as a first diffraction order of the continuous-wave laser beam in the acousto-optic modulator.

6. The method of claim 1, wherein the generating step generates the continuous-wave laser beam with a polarization extinction ratio of at least 15 decibels.

7. The method of claim 1, wherein the generating step generates the continuous-wave laser beam with at least 90% of its power in a single transverse mode.

8. The method of claim 1, wherein the cutting step includes:
focusing the pulsed laser beam on the metal foil, and
scanning a focus location of the pulsed laser beam along the metal foil such that respective centers of temporally adjacent pulses of the pulsed laser beam are spatially offset from each other.

9. The method of claim 8, wherein the scanning step traces a straight line on the metal foil, and wherein the method further comprises shaping the pulsed laser beam to have a rectangular transverse profile at the metal foil, a side of the rectangular transverse profile being parallel to the straight line.

10. The method of claim 1, wherein the generating step generates the continuous-wave laser beam with power spikes characterized by a peak power of at least three times an average power of the continuous-wave laser beam, the pulsed laser beam including some of the power spikes.

11. The method of claim 10, wherein duration of each of the power spikes is less than 400 picoseconds.

12. The method of claim 1, wherein the metal foil is an aluminum or copper foil.

13. The method of claim 1, wherein the metal foil has a coating disposed thereon.

14. An apparatus for laser cutting metal foils, comprising:
a fiber laser system configured to generate a continuous-wave laser beam of linear polarization;
an acousto-optic modulator arranged to receive the continuous-wave laser beam;
a radio-frequency generator configured to modulate diffraction of the continuous-wave laser beam by the acousto-optic modulator to produce a pulsed laser beam; and
a processing head configured to direct the pulsed laser beam to a metal foil and focus the pulsed laser beam on the metal foil.

15. The apparatus of claim 14, wherein the fiber laser system is configured to generate the continuous-wave laser beam with an average power of at least 0.5 kilowatts.

16. The apparatus of claim 14, wherein the fiber laser system is configured to generate the continuous-wave laser beam with a polarization extinction ratio of at least 15 decibels.

17. The apparatus of claim 14 wherein the acousto-optic modulator is configured to modulate the diffraction of the continuous-wave laser beam on and off at a modulation rate of at least 100 kilohertz.

18. The apparatus of claim 14, wherein the acousto-optic modulator is a compression-wave acousto-optic modulator.

19. The apparatus of claim 14, wherein the pulsed laser beam is a diffraction order of the acousto-optic modulator.

20. The apparatus of claim 14, to wherein the fiber laser system includes:
a fiber laser configured to generate a seed beam that is continuous-wave and linearly polarized, and
a fiber amplifier configured to amplify the seed beam to generate the continuous-wave laser beam.
